(19) United States
(12) Patent Application Publication
(10) Pub. No.: US 2018/0359029 A1
(43) Pub. Date: Dec. 13, 2018

(54) Distributed measurements and analysis in networks

(71) Applicant: Ciena Corporation, Hanover, MD (US)

(72) Inventors: Andrew D. Shiner, Ottawa (CA); Andrzej Borowiec, Ottawa (CA); Alex W. MacKay, Ottawa (CA); Maurice O'Sullivan, Ottawa (CA)

(21) Appl. No.: 16/107,079

(22) Filed: Aug. 21, 2018

Related U.S. Application Data
(63) Continuation-in-part of application No. 15/408,602, filed on Jan. 18, 2017, now Pat. No. 10,097,263.

(51) Int. Cl. H04B 10/079; H04Q 11/00

(52) U.S. Cl. CPC H04B 10/0795; H04Q 11/0067

(57) ABSTRACT

Systems and methods for distributed measurement in a network implemented by an orchestrator include directing one or more modules associated with one or more network elements to each perform a subset of the distributed measurement; receiving results from at least one network element of the one or more network elements based on the directing; and detecting an event or property based on the results. The subset of the distributed measurement can be based on performance monitoring data. The method can further include shuffling assignments for the distributed measurement between the one or more modules

### CROSS-REFERENCE TO RELATED APPLICATION(S)

The present patent/application is a continuation-in-part of U.S. patent application Ser. No. 15/408,602, filed Jan. 18, 2017, and entitled “USER DEFINED APPLICATIONS EXECUTED ON OPTICAL MODULES FOR PERFORMANCE MONITORING IN OPTICAL NETWORKS,” the contents of which are incorporated herein by reference.

### FIELD OF THE DISCLOSURE

The present disclosure generally relates to network measurement systems and methods. More particularly, the present disclosure relates to systems and methods for distributed measurements and analysis in networks.

### BACKGROUND OF THE DISCLOSURE

Network elements and associated equipment are utilized to implement various networking functions at Layers 0 (photonic), 1 (Time Division Multiplexing (TDM)), 2 (packet), etc. During operation, network elements are capable of logging a vast amount of Performance Monitoring (PM) data, but only a small fraction of the PM data can be captured and offloaded for external processing. The conventional approach to performance monitoring includes devices in a network element monitoring various data points, performing some processing locally, and providing the results of the processing to an external system (external from the network element such as a controller, Network Management System (NMS), etc.) such as via a backplane interface, a messaging bus, a Northbound Interface (NBI), etc. Also, the external system can also poll the module for information.

Importantly, there is a vast amount of Performance Monitoring (PM) data or other data (e.g., received symbols, corrected symbols, etc.) available for monitoring which may be captured but the majority of which is not provided to the external system in most cases due to bandwidth limitations. For example, the bandwidth limitations can be based on a Northbound Interface between a network element (i.e., node or shelf which operates a module) and an orchestrator as the external system (e.g., controller, NMS, etc.), but the bandwidth limitations can also be based on the backplane in the network element for communication between modules, and the like. For example, in an optical network element with tens of transceivers or more, it is not possible to provide all captured optical measurement data to the external system. There is simply too much data. Data may be captured when certain trigger conditions are met. This data conventionally is captured in buffers and written to files, but the vast amount of data limits the number of events which can be stored before the oldest events are discarded, and the storage is overwritten. That said, processing of this data can provide insights, trends, etc. which could be advantageous for proactive performance monitoring and optimization of the optical network.

Many processes that are of interest in a network occur over a wide range of time scales, and it is not practical to acquire the full range of data with a single network element. In this context, it would be advantageous to perform distributed measurements and analysis across multiple network elements to acquire a range of sampling conditions which would not be possible without a distributed measurement.

### BRIEF SUMMARY OF THE DISCLOSURE

This section will be the CLAIMS at the end rewritten in paragraph form once finalized

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1 is a network diagram of an example optical network with five interconnected sites;

FIG. 2 is a network diagram of a subset of the optical network of FIG. 1 showing the sites with optical modules forming an optical connection;

FIG. 3 is a block diagram illustrates functional components of the optical transceiver configured to operate in the distributed measurement framework;

FIG. 4 is a block diagram of functional components of an optical module adapted to execute distributed measurements;

FIG. 5 is a flowchart of a process for executing applications on an optical module which perform one or more optical functions;

FIG. 6 is a block diagram of an implementation of a server for implementing the orchestrator;

FIG. 7 is a network diagram of an optical network including three sites with associated modules executing distributed measurements and analysis with the orchestrator;

FIG. 8 is a flowchart of a distributed measurement process; and

FIG. 9 is a network diagram of a mesh optical network with a plurality of network elements interconnected to one another.

### DETAILED DESCRIPTION OF THE DISCLOSURE

The present disclosure relates to systems and methods for distributed measurements and analysis in networks. The systems and methods include a central orchestrator performing an experiment on a network where the orchestrator configures one or more network elements as well as one or more modules associated with the network elements to gather subsets of measurements which are required for the experiment. The approach is appropriate for situations where the data required for an experiment exists within the network but cannot be acquired by an individual network element. Modern network elements and modules can be configured to capture vast quantities of data including Performance Monitoring (PM) data. It is neither efficient to capture all of this data nor is it practical to export all of this data from the data capture device. Accordingly, the systems and methods described herein utilize a distributed measurement approach with a centralized orchestrator.

By distributing the measurement across multiple network elements and/or modules it is possible to acquire over a range of sampling conditions which would not be possible without a distributed measurement. In an embodiment, machine learning with distributed measurement can be used to search for correlations between many permutations of PM data. By having the orchestrator configure the network elements and/or modules to search for correlations between subsets of PM data, it is possible to discover subtle correlations which would be very difficult to detect.

An experiment can be defined by a user in a program that runs as part of the orchestrator. That program can have knowledge of the topology of the network and may include external data sources such as weather, transportation information, or the like. The program would define parameters to be measured or an algorithm for determining parameters to be measured. It would then select network elements and/or modules to participate in the experiment and assign measurements to individual network elements and/or modules. It could also define processing steps which are to be completed within each network element and/or module as well as conditions for event triggers to be sent to other network elements, modules, or the orchestrator. The experiment can run in the network for a defined period of time after which the orchestrator would gather the data from the network elements and/or modules, process the results, and distribute new measurement assignments to the network elements and/or modules.

The distributed measurements and analysis can be performed at the network elements and/or modules in the network. In an embodiment, this functionality can be performed in the hardware, software, and/or firmware therein, such as part of a network element operating the software. In another embodiment, user-defined applications can be provided to modules in the network element for the distributed measurements and analysis. For example, user-defined applications are described in commonly-assigned U.S. patent application Ser. No. 15/408,602, filed Jan. 18, 2017, and entitled “USER DEFINED APPLICATIONS EXECUTED ON OPTICAL MODULES FOR PERFORMANCE MONITORING IN OPTICAL NETWORKS,” the contents of which are incorporated by reference herein.

There is a vast amount of data captured in optical modules (e.g., transceivers, amplifiers, wavelength switches, etc.). Systems and methods described herein can provide a framework with these modules for distributed measurements and analysis executed on the modules using the data capture or other data for performance monitoring and the like. The data capture, data analysis, etc. are executed on compute resources on optical modules and other modules in the network elements with access to the PM data and other data through Application Programming Interfaces (APIs). End users can be allowed to add these applications in the framework, and the applications are segregated such that their operation is non-intrusive to the core functionality performed by the module, i.e., the compute resources are isolated from resources associated with the core functionality. The end users can groom the PM data as needed, monitor for defined events, either log the events or alert an orchestrator, and the like. Such a framework opens up the optical network for sophisticated performance monitoring or other applications leading to proactive control.

The ability to deploy applications onto a network element improves an operator's ability to measure, monitor, control, optimize, and provision the state of their network. Large carriers, and particularly Over the Top (OTT) providers are very motivated to increase their ability to monitor and control their network elements through software, as evidenced by the drive towards Software Defined Networking (SDN). The distributed measurement framework described herein takes advantage of data flows that are far too large to aggregate back to a central orchestrator (higher layer controller) for processing outside of a module, line card, optical transceiver, etc. The distributed measurement framework can be programmed to define complex error conditions and to signal the operator when those conditions are satisfied. Enabling operators to run their own experiments in a network element will provide a more detailed picture of the state of the network than would otherwise be possible, leading to proactive maintenance, better performance, etc. Importantly, this framework executes these measurements in a sandboxed manner such that the applications do not interfere with the operation of the modules.

### Example Optical Network

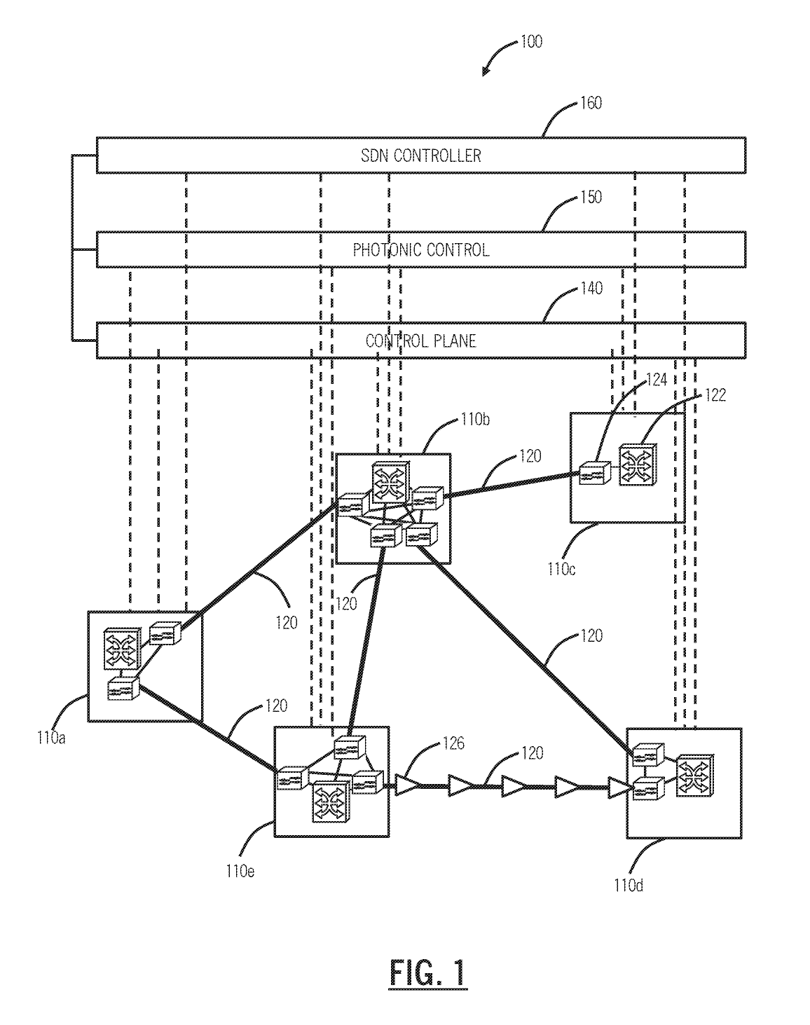

FIG. 1 is a network diagram of an example optical network 100 with five interconnected sites 110 (labeled as 110a, 110b, 110c, 110d, 110e). The sites 110 are interconnected by a plurality of links 120. Each of the sites 110 can include a switch 122 and one or more Wavelength Division Multiplexing (WDM) network elements 124. The switch 122 is configured to provide services at Layers 1 (e.g., Optical Transport Network (OTN)) and/or Layer 2 (e.g., Ethernet). The WDM network elements 124 provide the photonic layer (e.g., Layer 0) and various functionality associated therewith (e.g., multiplexing, amplification, optical routing, wavelength conversion/regeneration, local add/drop, wavelength switching, etc.) including photonic control. Of note, while shown separately, those of ordinary skill in the switch 122 and the WDM network elements 124 may be realized in the same network element. The photonic layer and the photonic control operating thereon can also include intermediate amplifiers 126 and/or regenerators (which are omitted for illustration purposes) on the links 120. The optical network 100 is illustrated, for example, as an interconnected mesh network, and those of ordinary skill in the art will recognize the optical network 100 can include other architectures, with additional sites 110 or with fewer nodes sites, with additional network elements and hardware, etc. Those of ordinary skill in the art will recognize the systems and methods described herein can be used in any optical networking scenario for the optical network 100, such as data center, metro, regional, long-haul, or submarine applications. The optical network 100 is merely presented for illustration purposes.

Realization of the optical network 100 is via the switch 122, the WDM network elements 124, and/or the amplifiers 126 and with associated optical modules therein. The distributed measurement framework described herein operates with the optical modules in the context of their operation in the optical network 100. Three example optical modules include a transceiver (TX/RX) (also referred to as a transponder, a modem, a line card, etc.), an amplifier (e.g., an Erbium Doped Fiber Amplifier (EDFA), a Raman amplifier, etc.), and an optical switch (e.g., Wavelength Selective Switch (WSS)). Each of these optical modules is adapted to capture a vast amount of PM data related to its corresponding operation (examples are described herein). Again, as described herein, a large amount of the data remains on the optical module and can be lost or written over after a time period (e.g., minutes). The distributed measurement framework described herein enables performing various functions locally with the data and globally with a centralized orchestrator.

The sites 110 are connected with one another optically over the links 120. The sites 110 can be network elements which include a plurality of ingress and egress ports forming the links 120. As described herein, a port may be formed by a transceiver module to provide an optical connection between the sites 110. The optical network 100 can include a control plane 140 operating on and/or between the switches 122 at the sites 110. The control plane 140 includes software, processes, algorithms, etc. that control configurable features of the optical network 100, such as automating discovery of the switches 122, capacity of the links 120, port availability on the switches 122, connectivity between ports; dissemination of topology and bandwidth information between the switches 122; calculation and creation of paths for connections; network level protection and restoration; and the like. In an embodiment, the control plane 140 can utilize Automatically Switched Optical Network (ASON), Generalized Multiprotocol Label Switching (GMPLS), Optical Signal and Routing Protocol (OSRP) (from Ciena Corporation), or the like. Those of ordinary skill in the art will recognize the optical network 100 and the control plane 140 can utilize any type control plane for controlling the switches 122 and establishing connections. In an embodiment, the control plane 140 can support distributed measurement functionality between the optical modules in the switches 122, the WDM network elements 124, the amplifiers 126, etc.

The optical network 100 can include photonic control 150 which can be viewed as a control algorithm/loop for managing wavelengths/spectrum from a physical perspective at Layer 0. In one aspect, the photonic control 150 is configured to add/remove wavelengths/spectrum from the links in a controlled manner to minimize impacts to existing, in-service channels. For example, the photonic control 150 can adjust modem launch powers, optical amplifier gain, Variable Optical Attenuator (VOA) settings, WSS parameters, etc. The photonic control 150 can also be adapted to perform network optimization on the links 120. This optimization can also include re-optimization where appropriate. In an embodiment, the photonic control 150 can adjust the modulation format, baud rate, frequency, wavelength, spectral width, etc. of the dynamic optical transceivers in addition to the aforementioned components at the photonic layer. In an embodiment, the photonic control 150 can support end-user application centralized/distributed storage and delivery of applications to optical modules in the switches 122, the WDM network elements 124, the amplifiers 126, etc.

The optical network 100 can also include a Software Defined Networking (SDN) controller 160. SDN allows management of network services through abstraction of lower level functionality. This is done by decoupling the system that makes decisions about where traffic is sent (SDN control through the SDN controller 160) from the underlying systems that forward traffic to the selected destination (i.e., the physical equipment in the optical network 100). Work on SDN calls for the ability to centrally program provisioning of forwarding on the optical network 100 in order for more flexible and precise control over network resources to support new services. The SDN controller 160 is a processing device that has a global view of the optical network 100. Additionally, the SDN controller 160 can include or connect to SDN applications which can utilize the data from the SDN controller 160 for various purposes. In an embodiment, the SDN applications can support end-user application centralized/distributed storage and delivery of applications to optical modules in the switches 122, the WDM network elements 124, the amplifiers 126, etc.

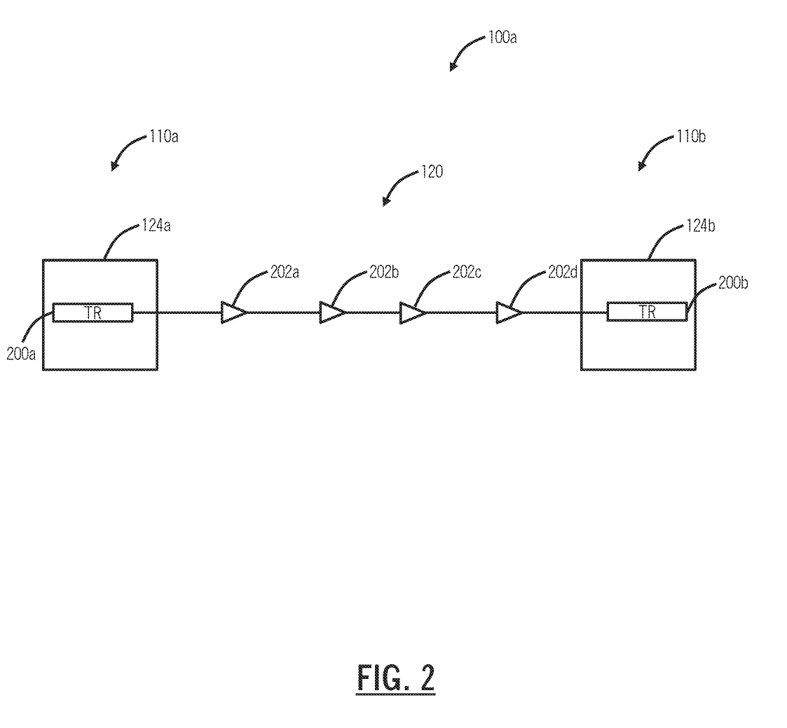

FIG. 2 is a network diagram of a subset 100a of the optical network 100 showing the sites 110a, 110b with optical modules 200, 202 forming an optical connection. In an embodiment, the sites 110a, 110b include the WDM network elements 124a, 124b which each include a transceiver 200a, 200b. On the link 120, various amplifiers 202 (labeled as 202a, 202b, 202c, 202d) are located between the WDM network elements 124a, 124b. Each of the transceivers 200 and the amplifiers 202 are examples of optical modules capable of operating in the framework described herein. The optical connection between the WDM network elements 124a, 124b can be over a wavelength or group of optical spectrum carrying any type of traffic such as, without limitation, OTN, SONET, SDH, Ethernet, Frame Relay, IP, MPLS, and the like as well a combinations thereof.

The links 120 can include any type of optical fiber. For example, the optical fiber can include a useable optical spectrum of 1530 nm to 1565 nm (C-Band). Of course, other portions of the spectrum are contemplated. The optical spectrum can be partitioned into a flexible grid, a fixed grid, gridless, or a combination across the optical spectrum. Thus, each of the links 120 and their associated optical fiber can support a fixed or variable number of wavelengths (wavelengths can also be referred to as optical signals). The wavelengths traverse a channel which carries an underlying service between the sites 110a, 110b. Parameters associated with each of the wavelengths can include—A-Z path in the network, spectrum allocation (e.g., fixed spectrum, flexible spectrum, amount of spectrum, location on the spectrum, etc.), modulation format, baud rate, Forward Error Correction (FEC) parameters, optical power, dispersion compensation, Polarization Mode Dispersion (PMD) compensation, non-linear compensation, polarization state, etc.

### Optical Transceivers

Generally, the optical transceiver 200 is associated with the optical signal which is the result of modulating an electrical signal onto an optical carrier. That electrical signal may have a single carrier such as with a single Time Division Multiplexing (TDM) stream of Quadrature Phase Shift Keying (QPSK) symbols, Quadrature Amplitude Modulation (QAM), Higher order modulation formats e.g., X-constellation, a plurality of carriers such as with Frequency-Division Multiplexing (FDM), or a very large number of carriers such as with Orthogonal Frequency-Division Multiplexing (OFDM). Also, the optical transceiver 200 can use polarization multiplexing with any of the foregoing modulation formats. Any type of modulation scheme is contemplated. In an embodiment, each optical transceiver 200 is tunable so that it can selectively generate a modulated carrier centered at the desired wavelength (or frequency). In embodiments in which tunable optical transceivers 200 are used, the wavelength range of each optical transceiver 200 may be wide enough to enable the optical transceiver 200 to modulate any wavelength within a region of the optical spectrum such as the C-band. In other embodiments, the wavelength range of each optical transceiver 200 may be wide enough to enable the modem 200 to generate any one of a subset of wavelengths in the optical spectrum.

The optical transceivers 200 can support various different baud rates through software-programmable modulation formats. The optical transceivers 200 can support programmable modulation or constellations with both varying phase and/or amplitude. In an embodiment, the optical transceivers 200 can support multiple coherent modulation formats such as, for example, i) dual-channel, dual polarization (DP) binary phase-shift keying (BPSK or X-Constellation) for 100G at submarine distances, ii) DP-QPSK for 100G at ultra-long haul distances, iii) 16-QAM for 200G at metro to regional (600 km) distances), or iv) dual-channel 16QAM for 400G at metro to regional distances. In another embodiment, the optical transceiver 200 can support N-QAM modulation formats with constellation shaping with and without dual-channel and dual-polarization where N can even be a real number and not necessarily an integer. Here, the optical transceiver 200 can support non-standard speeds since N can be an effective real number as opposed to an integer, i.e., not just 100G, 200G, or 400G, but variable speeds, such as 130G, 270G, 560G, etc. These rates could be integer multiples of 10 Gb/s, or of 1 Gb/s.

Furthermore, with Digital Signal Processing (DSP) and software programming of the optical transceiver 200, the capacity of the optical transceiver 200 can be adjusted upwards or downwards in a flexible and hitless manner so as not to affect the guaranteed rate. In other embodiments, the optical transceiver 200 can include hardware which lacks the aforementioned functionality and thus supports a single modulation format/baud rate which cannot be adjusted (but other parameters that can be adjusted for power, spectral location, etc.). Additionally, the optical transceiver 200 can tune and arbitrarily select spectrum; thus, no optical filters are required. Additionally, the optical transceiver 200 can support various aspects of linear propagation effect mitigation (chromatic and polarization mode dispersion) as well as nonlinear propagation effect mitigation such as self-phase modulation, cross phase modulation, cross-polarization modulation and four-wave mixing in the electrical domain via appropriate DSP, thus eliminating external dispersion compensation devices, filters, etc. The optical transceiver 200 can also adapt the forward error correction coding that is used including Hard Decision FEC implementations and Soft Decision FEC (SD-FEC), as another technique to trade-off complexity versus noise tolerance.

In general, the bit rate of the service provided by a modem is proportional to the amount of spectrum occupied and is a function of the noise tolerance. The optical transceiver 200 can include coherent receivers which require no optical dispersion compensation or optical filters (multiplexers and demultiplexers). Also, the optical transceiver 200 can support advanced Performance Monitoring (PMs) for feedback such as Bit Error Rate (BER), Polarization Dependent Loss (PDL), Polarization Mode Dispersion (PMD), and the like to provide accurate modeling of optical characteristics. The optical transceiver 200 can include coherent transmitters which can provide spectral shaping allowing for more efficient spectrum use and flexible grid placement. Also, the coherent transmitters support software-selectable modulation formats allowing for optimal matching of the formats spectral efficiency to the given link condition.

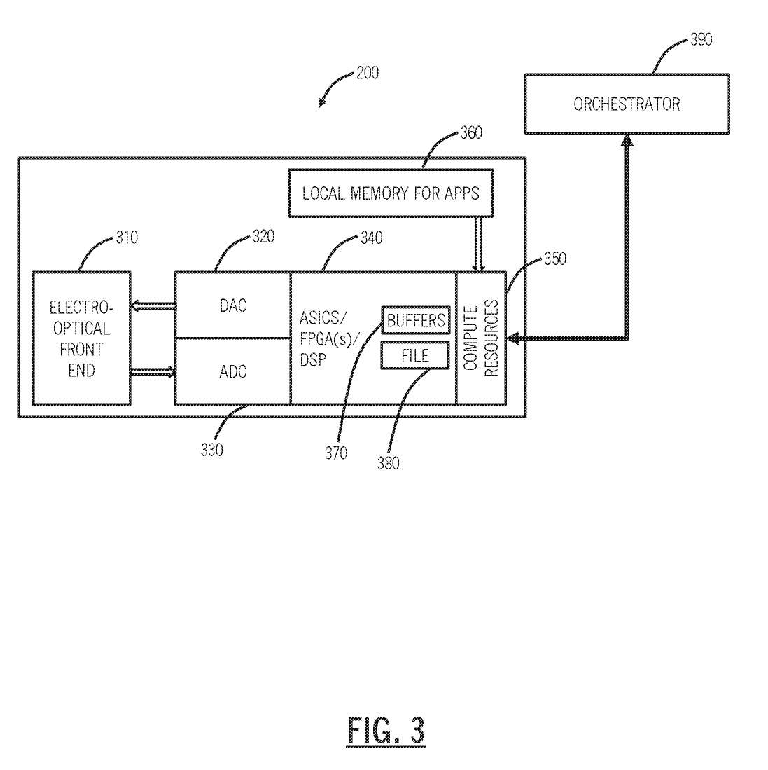

FIG. 3 is a block diagram illustrates functional components of the optical transceiver 200 configured to operate in the distributed measurement framework. The optical transceiver 200 is an integrated hardware device that may be realized as a line card, line module, pluggable module, blade, daughter board, etc. The integrated hardware device includes a form-factor for operation in or with the switches 122, the network elements 124, or the like. Functional components of the optical transceiver 200 include an electro-optical front end 310, a Digital-to-Analog Converter (DAC) 320, an Analog-to-Digital Converter (ADC) 330, processing circuitry 340, compute resources 350, a local memory 360. The electro-optical front end 310 provides conversion between optical and electronic domains. The electro-optical front end 310 includes a transmitter and a receiver. The transmitter generally includes a laser and a modulator. The transmitter is configured to receive a transmit signal from the DAC 320 in analog form to drive the modulator to transmit optically the transmit signal. The receiver can include various detectors, a local oscillator (LO), and polarization components. The receiver receives a received signal optically, performs detection of an electrical signal, and provides an analog electrical signal to the ADC 330 for digital conversion thereof.

The DAC 320 and the ADC 330 provide conversion between electrical signals the analog domain and the digital domain and are connected to processing circuitry 340 for digital signal processing functions. The processing circuitry 340 can include Application Specific Integrated Circuits (ASICs), Field Programmable Gate Arrays (FPGAs), DSPs, combinations thereof, as well as other digital processing circuit devices. The processing circuitry 340 is generally configured to perform digital processing on received signals from the electro-optical front end 310 and on transmit signals to the electro-optical front end 310. This digital processing can include various functions such as, without limitation, FEC, dispersion equalization, polarization tracking, modulation/demodulation, non-linear effect compensation, spectral slicing, framing, coherent detection, timing recovery, performance monitoring, and the like. During operation, the processing circuitry 340 obtains various measurements, i.e., PM data, related to any of the aforementioned functions as well as other functions. The data may be stored in buffers 370 (short-term memory) which can be written to a file 380 and stored. As described herein, the vast majority of the data is not provided to a higher layer controller via the backplane or northbound interface due to its sheer volume. Note, the buffers 370 and the file 380 can be memory circuits, and, in an embodiment, the initial data may be written to the buffers 370, then to the file 380, but in the aggregate, the amount of data captured (until written over) is limited. Also, all of the data is not necessarily written into the buffers 370 and then to the file 380, but rather just discarded. A small fraction of it may be captured possibly following some sort of defined trigger event, but the amount of data that can be captured and fed back is limited.

The compute resources 350 include local processing resources on the optical transceiver 200 and can include one or more Central Processing Unit (CPU) cores, FPGAs, Virtual Machines (VMs), etc. The compute resources 350 generally include any device for executing software instructions. In operation, the compute resources 350 are configured to execute software stored within a memory in the compute resources 350 and/or the local memory 360, to communicate data to and from the memory, and to generally perform operations for the compute resources 350 pursuant to the software instructions. The compute resources 350 are communicatively coupled to the buffers 370 and/or the file 380 and configured to access the PM data therein, such as through an API. In another embodiment, the processing circuitry 340 and the compute resources 350 can share the same hardware.

In an embodiment, the systems and methods include execution of user defined applications on the compute resources 350 for purposes of performing any functions with the PM data. The optical transceiver 200 can include core resources which perform functions related to the operation of the optical transceiver 200. Here, the compute resources 350 are segmented such that operation of the user-defined applications does not interfere with the operation of the optical transceiver 200 by isolating the core resources from the compute resources 350, except through APIs or the like which are tightly controlled. Thus, the compute resources 350 can be dedicated to executing the user defined applications, without affecting the on-going operation of the optical transceiver 200.

In an embodiment, the optical transceiver 200 has access to a large number (thousands) of PMs. The compute resources 350 can be configured to execute the user defined applications with this PM data. An orchestrator 390 could communicate with the optical transceiver 200 through the messaging bus (e.g., NMS, Northbound interface, Data Communications Manager (DCM), etc.) which could upload the user defined applications to the optical transceiver 200. As described herein, the orchestrator 390 can be executed on some higher layer controller, such as an NMS, Element Management System (EMS), SDN controller or application, etc. The orchestrator 390 can facilitate the creation, monitoring, and deployment of resources associated with the user-defined applications described herein. The orchestrator 390 could poll the state of the application (a pull request), or it could wait to be contacted by the module (a push request) when a set of conditions that are defined within the application are met.

Typical functionality for the application could include simple monitoring and logging of PMs, performing calculations based on PM values, training machine learning algorithms by searching for correlations between PMs, building histograms of PM values, etc. Software running on the orchestrator 390 can define a study and then deploy the distributed measurement containing that study onto one or more modules in a network which will participate in the study. The study can use some combination of PM values or other data to calculate some measure of performance, e.g., polarization activity. At the same time, other modules can be in different studies, e.g., looking for polarization events with a different signature. At any given time, the modules in a network can each be participating in one or more studies (which can also be referred to as experiments, tests, etc.). The orchestrator 390 can keep track of this and over a time cycle each study through a number of different modules in the network. In addition to studies, the distributed measurement can be used to create new alarms or warnings based on calculations performed on some combination of PM values and their histories. Various other embodiments are contemplated with the PM values. Advantageously, end users or operators can add distributed measurements without having to obtain a firmware upgrade, new software release, etc. Further, vendors do not need to be concerned about the quality of the applications because their ability to do harm is limited through providing and the design of the API.

User-Defined Applications with an Optical Transceiver

Assume the optical transceiver 200 is a coherent optical modem which supports dual polarization transmission. Again, the optical transceiver 200 with the ability to execute distributed measurements includes a collection of hardware and software which will enable a network operator to monitor and act upon a large amount of PM data produced by the optical transceiver 200. The coherent optical modem can support functionality which allows the user to monitor one or more PMs and to record the state of a subset of those monitors when one or more of their values crosses pre-defined threshold values. A user can write an app that runs on the module, e.g., the optical transceiver 200. The app can monitor one or more PMs, perform calculations or other operations on the PM data, and record the state of the PMs and/or the results of those calculations either continuously or when one or more conditions that are defined within the app are satisfied. The logged values or results can be stored and can be downloaded from the optical transceiver 200 by the operator. One example of information that may be available to an app through the API is received symbols and the corresponding ideal symbols that are calculated based on the post-FEC bits that were transmitted by that symbol. These would be available for some fraction of the received symbols.

Using the captured symbols, a multiplicity of measurements are possible such as: 1) the distribution of Bit Error Rate (BER) per half burst; 2) mutual information per half burst; 3) time-dependent polarization; 4) received intensity noise/power fluctuations; 5) phase and amplitude noise statistics; and the like.

In many cases, the PM data has value at the network level for monitoring and optimizing the performance of the network. In a traditional workflow, the triggers on the optical transceiver 200 are set to trigger once a PM reaches a threshold that corresponds to a given condition. Once triggered, the PM values are stored locally and later downloaded by the operator or the orchestrator 390 which performs additional processing and analysis. The challenge with this model is that the trigger events are usually limited to simple threshold crossings, and a large amount of data must be sent back to the Network Operations Center (NOC) for processing. The bandwidth requirements for passing PM data back to the NOC will become more severe for the coherent optical modem where a fraction of all symbols can be available in the form of captured half bursts. In normal operation, it will not be feasible to aggregate that quantity of data to a central location for processing. For example, future modems or optical transceivers 200 will have the ability to capture a small fraction, e.g., 0.1% of the received bursts of symbols, and to relate those symbols to the ideal error-free transmit symbols which are calculated based on the error-free bits following FEC. This data can be processed in a lot of different ways to learn about the condition of the link as well as the optical transceiver 200. Because of the huge volume of data created it will not be possible in most cases to send it to a central location for processing. Calculations performed on this data can be limited to those which can be carried out on the optical transceiver 200, utilizing the systems and methods described herein. Specifically, the use of locally executed user applications allows processing of data in ways that the manufacturer did not define in firmware.

Accordingly, the systems and methods allocate the compute resources 350 for running customer supplied software or applications (“user-defined applications”) which would have access to a chosen set of PMs through a defined API. The applications can run in a sandboxed environment with access to the PMs as well as the northbound network moderated by the API. By sandboxed environment, operations of the applications in the compute resources 350 do not affect the operation of the optical transceiver 200 (or another type of optical module). This is analogous to apps running on a smartphone where the smartphone allows a subset of its devices such as the accelerometer, magnetometer, microphone, speaker, GPS, screen, etc. to be accessed by user-supplied apps running on the phone but where access is limited or controlled by pre-defined devices and resources on the phone.

Again, the systems and methods provide a framework where operators can deploy applications directly into the optical transceiver 200 for the purpose of acting upon data which is available within the optical transceiver 200 or obtained by the optical transceiver 200. This gives the operator the ability to groom and compress the data in a manner that can be specifically tailored to an operator's emerging needs.

The foregoing describes some non-limiting examples of user-defined applications. Those of ordinary skill in the art will recognize any type of application is possible to make use of current or future data that is available.

First, with an optical transceiver 200, one out of every 1000 half bursts will be available to firmware and could be made accessible to an application through an API. For each half burst, the data could include 4 tributaries×9 bits/trib.×256 symbols/HB=9216 bits per half burst with a sniffing rate of one out of every 1000 half bursts giving a total data rate of 0.3 GB/s (@70 GBaud). Again, aggregating this data back to the NOC for processing is not practical. It will also be very difficult to anticipate all of the measurement scenarios that would be of interest to the operator. Possible examples include building up a probability distribution of the BER per half burst or the Mutual Information (MI) per half burst. Accumulated over several hours such a distribution can be used to predict the probability of frame errors. Hundreds of gigabytes of data are reduced to a few kilobytes in the form of a file or other form of data (e.g., data sent via REST commands or other approaches) which can easily be returned to the orchestrator 390, NOC, etc.

Second, the operator can define the characteristics of an event such as a polarization transient and can program an application to identify and parameterize transient events. Using the sniffed data from the previous example, the application can calculate the Stokes space representation of the error field (the difference between received symbol and known transmit symbols) and can monitor the rate of change of that error either within a half burst or comparing between sniffed half bursts. This data could be combined with other measures such as the Least Mean Square (LMS) tap coefficients to quantify the polarization activity associated with the channel. The transient events can be quantified in terms of their magnitude and duration, harmonic content, etc., and logged with a time stamp from a real-time clock that would also be available through the API.

In an embodiment, the optical transceiver 200 can signal the NOC, the orchestrator 390, etc. when an error condition is satisfied. The optical transceiver 200 could also signal other modules. For example, if one optical transceiver 200 detects a frame error, it could signal to the other modules on the link that the event occurred. Apps running on the other module could be programmed to record the state of their PMs or calculated quantities based on their PMs. If a polarization transient is suspected as responsible for one module experiencing a frame error, it would be useful to know if the other modules experienced significant polarization activity at the time of the frame error.

Third, recently machine learning has been used to discover the subtle relations between PMs that are indicative of the health of a coherent modem or network. Again, the optical transceiver 200 has thousands of PMs, so it is not practical to search for relevant correlations by sending all of the data to a central location. Using an application, deep learning algorithms could be instantiated within the optical transceiver 200 and programmed to look for the correlation between a subset of PMs and a measure of performance such as BER. Each optical transceiver 200 in the network can be participating in one of these studies, each with different combinations of data. Over time the combinations of data examined by each optical transceiver 200 can change with a central orchestrator 390 looking for which combinations of monitors proved to have the most relevance for predicting performance. By having a central orchestrator 390 distribute the machine learning activities to a large ensemble of optical transceivers 200 or other optical modules, it should be possible to discover correlations between data much faster than would otherwise be possible.

Fourth, an application could be programmed to monitor the customer traffic payload and to act when specific contents or patterns of activity are observed. Examples include logging the occurrences of packets with some specific header information or bursts of packets of a particular size from a given origin. When a debit terminal processes a transaction its interaction with the bank likely has an identifiable signature; the optical transceiver 200 could be programmed to detect and log those events. Here, the application can extract all or part of the client payload data for processing. Applications include measuring usage from a given origin based on header information, defining a data sequence with a particular signature and logging times when that signature is observed, and the like. This functionality may be used to intercept and store packets from a particular origin.

Fifth, a coherent modem transmits data at a constant rate regardless of whether or not client data is being transmitted. An application could detect empty packets and replace them with data from a buffer. The receiver would place these packets into its buffer and reinstall the empty packets. This mechanism would allow for the transport of low priority data from one modem to another without interfering with customer traffic.

Sixth, applications running on each optical transceiver 200 could be programmed to detect error conditions and to push an alarm to the NOC instead of waiting for the NOC to poll the state of the optical transceiver 200. In this scenario, bandwidth/time is not wasted interrogating optical transceivers 200 which are operating normally. Also, the definition of what constitutes an error condition can be specified in great detail within the application and can continue to evolve along with the operator's knowledge of what matters to the performance of the network.

Variously, the application can perform some local processing or analysis of the data on the optical module or transceiver 200 to reduce the amount of data transmission between the orchestrator 390 and the optical module or transceiver 200, etc. The application can calculate or derive measurements from the PM data and/or the history and present the results in a summarized manner such as a histogram or other type of plot, table, etc. The use of the application can provide results such as histograms or error events to a distributed messaging system such as Apache Kafka.

For the optical transceiver 200, such as a coherent modem, the availability of received symbols and the corresponding error-free bits prior to carrier recovery can enable in-service diagnostic measurements, which can be made available to the end users via the user-defined applications described herein. The ‘sniffed’ received symbols, and the corresponding error-free bits (which can be used to get the ideal transmitted constellation points) are one example of the data which could be available to an app through the API. Note, the apps are not limited to performing operations on PM data, but any data associated with the optical transceiver 200 or modules, such as received symbols, corresponding error-free bits, or any other data. Examples of in-service measurements (PM data) include, without limitation, Optical Signal-to-Noise Ratio (OSNR) and Q-factor variations (Q-factor is a known technique for characterizing an optical channel); recording the magnitude, duration, and distribution of polarization transient events; recording the cycle-slip location and frequency within a burst; noise correlation statistics; extracting nonlinear coefficients for use in network simulations; identifying parameters for nonlinear compensation provisioning and budgeting; and the like.

Because measurements are in-service, a large operator may choose to have all of their optical transceivers 200 participating in one or more studies with data aggregated back to the orchestrator 390 to enable network analytics to be used to measure and predict the health of the network. The data can be sampled at different rates and combined in different ways. For example, an experiment can be designed to look for polarization transients with a certain rotation rate and particular characteristics. That could define one study that could be assigned to a fraction of the modules in an operator's network. Another experiment could look for transients at a different rotation rate or to look to see if they are correlated with some other PM, and this could be assigned to other modules. Thus, a set of studies can be designed and assigned to various modules. These studies could be shuffled over time between the modules. This could be used for machine learning applications where the modules would look for correlations between various PMs and some measure of performance. For example, an operator could think of all of the PMs that might be related and then define studies to ask a given module to look for correlations between a subset of the PMs and a measure of performance (BER, Frame Error Rate (FER), etc.). Different modules would look at different combinations and the orchestrator 390 would monitor the results and occasionally shuffle the studies between the modules.

Again, the orchestrator 390 is adapted to provide the applications to the optical transceiver 200 or optical modules. In an embodiment, the orchestrator 390 can include a database of applications which can be selected as appropriate or desired by operators and configured and uploaded to optical transceiver 200 or optical modules on the network. The framework can include an application publishing concept where end users can write their own applications and provide to the orchestrator 390, or directly to the modules. Apps can be written by equipment vendors, operators or third parties. The apps are uploaded to and run on the optical transceiver 200 or optical modules. In some cases, the orchestrator 390 is used to upload the app onto the optical transceiver 200 or optical modules. Also, operators can also select applications as well. The applications can be referred to as end-user applications in a sense they are written by the end users, not the equipment manufacturer or vendor of the optical transceiver 200 or optical module. Of course, the equipment manufacturer or vendor can also write applications and may offer a suite of applications as well. The key here is that anyone can write an app for the optical transceiver 200 or optical modules and change which apps are running on the optical transceiver 200 or optical modules without having to change the firmware.

### Optical Module

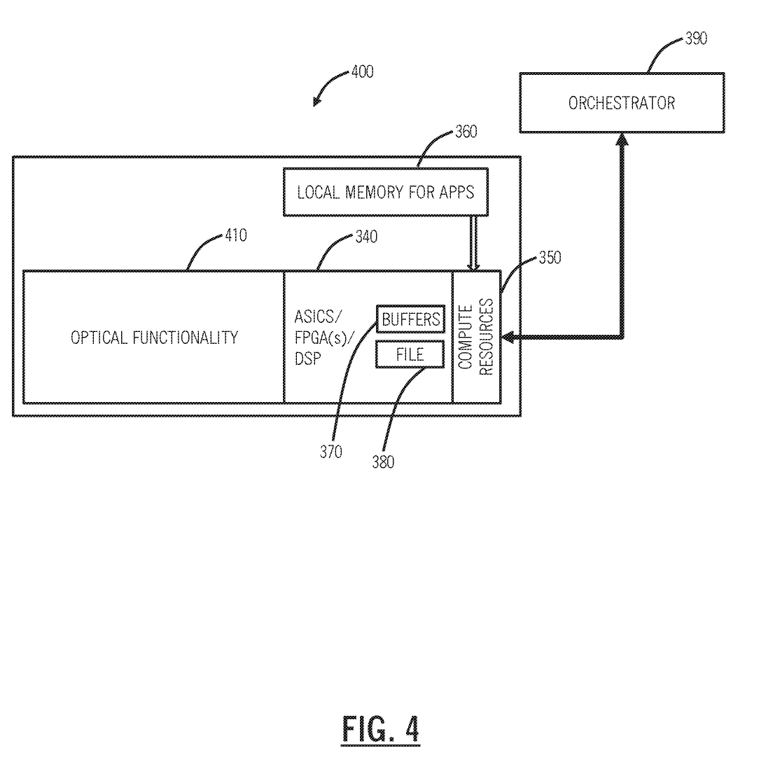

FIG. 4 is a block diagram of functional components of an optical module 400 adapted to execute distributed measurements. The optical module 400 is shown in a general form to represent any type of optical module in a network element (e.g., the network elements 122, 124, 126) that has data captured or obtained and which can execute distributed measurements. For example, the optical module 400 can be the optical transceiver 200. Also, the optical module 400 can be an amplifier module (e.g., EDFA, Raman, etc.), a Wavelength Selective Switch (WSS), an Optical Power Monitor (OPM), a multiplexer/demultiplexer, or the like. The optical module 400 operates in a similar fashion as the optical transceiver 200 from the perspective of the user-defined applications. Specifically, the optical module 400 includes the processing circuitry 340, the compute resources 350, the local memory 360, the buffers 370, and the file 380. Additionally, the optical module 400 includes optical components 410 to perform some form of optical functionality, e.g., amplification, power monitoring, gain control, modulation/demodulation onto/from an optical carrier, multiplexing/demultiplexing, etc.

In an embodiment, the optical module 400 is adapted to operate in an optical network to perform one or more optical functions therein. The optical module 400 includes optical components 410 adapted to perform one or more functions associated with the optical module 400; processing circuitry 340 communicatively coupled to the optical components 410 and adapted to obtain data such as data generated or obtained during operation of the one or more optical functions; and compute resources 350 communicatively coupled to the processing circuitry 340 and adapted to receive, such as via an orchestrator 390, an application for local execution on the compute resources 350 in a sandboxed manner, and analyze, by the application, the data to perform one or more analysis functions thereon. The sandboxed manner includes the application being constrained to access the data and analyze the data such that the application does not interfere with the operation of the optical module 400. Specifically, the sandboxed manner refers to an application that executes on the compute resources 350 that are allocated on the optical module 400 for the purpose of running the app, and where the compute resources 350 are isolated from the core resources of the optical module 400 except for those resources which are made available to the app by the hardware vendor or manufacturer either through provisioning or through an API. Resources may include compute, memory, access to performance monitor and other types of data, internal and external network interfaces such as SPI and the northbound network as well as volatile and nonvolatile storage.

The application one or more of pushes data to the orchestrator 390 or to another application on the optical module 400 or on another optical module 400 based on analysis, and receives a poll from the orchestrator 390 or from another application on the optical module 400 or on another optical module 400. The application could also be polled by another application on the same module or a different module or in a more typical scenario it would be polled by the orchestrator 390. Similarly, the application can push or initiate communication with the orchestrator 390 or other apps that can reside on the same module or other modules. The compute resources 350 can be adapted to access the data via an API and wherein the compute resources 350 are adapted to communicate with the orchestrator 390 via a messaging bus associated with a network element housing the optical module 400. The data can be stored in one or more of buffers 370 and a file 380, the PM data can be transient and stored for a temporary period of time. The one or more analysis functions can include monitoring and logging specific data, performing calculations based on the data, searching for correlations between the data, and building histograms of the data. The one or more analysis functions can define one or more error conditions based on the data or calculations derived therefrom. The data can further include data from external sources including other applications running on the optical module 400, other applications running on other optical modules 400, and the orchestrator 390. The orchestrator 390 can be executed on one or more of a Network Management System (NMS), an Element Management System (EMS), a Software Defined Networking (SDN) controller, and a server executing an SDN application. The application can be written by an end user separate from a manufacturer or developer of the optical module 400, although other embodiments are contemplated. The optical module 400 includes one of an optical transceiver 200, an optical amplifier 202, an optical switch device, an Optical Power Monitor (OPM), a multiplexer/demultiplexer, and any other module or device performing some functionality in the optical network.

### Process for Executing Applications on an Optical Module

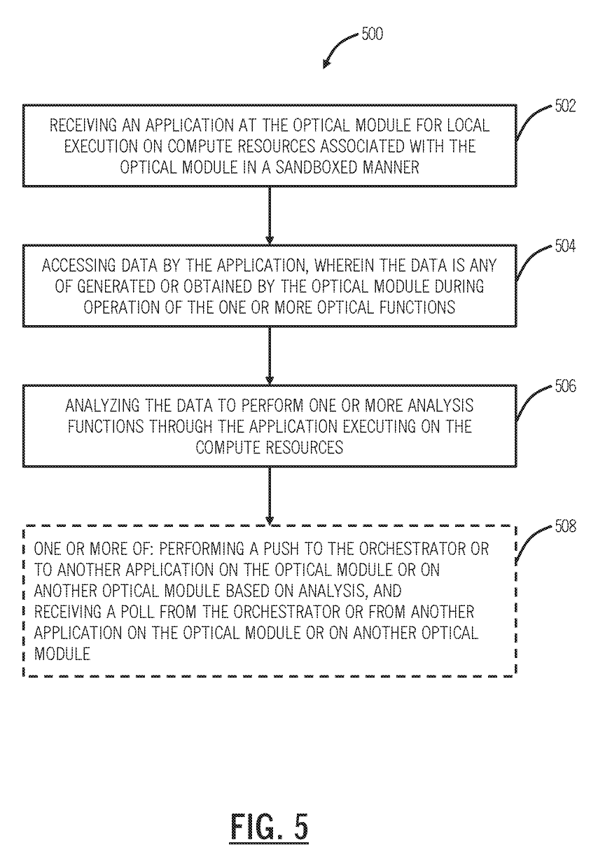

FIG. 5 is a flowchart of a process 500 for executing applications on an optical module 200, 202, 400 which perform one or more optical functions. The process 500 includes receiving an application at the optical module for local execution on compute resources associated with the optical module in a sandboxed manner (step 502); accessing data by the application, wherein the data is any of generated or obtained by the optical module during operation of the one or more optical functions (step 504); analyzing the data to perform one or more analysis functions through the application executing on the compute resources (step 506). As described herein, the data accessed or obtained by the application can be PM data or any other type of data. The sandboxed manner can include the application being constrained to access the data and analyze the data through execution on resources isolated from core resources associated with the one or more optical functions. The application can perform one or more of pushing data to the orchestrator or to another application on the optical module or on another optical module based on analysis, and receiving a poll from the orchestrator or from another application on the optical module or on another optical module (step 508). The one or more analysis functions can define one or more error conditions based on the data or calculations derived therefrom. The data can further include data from external sources including other applications running on the optical module, other applications running on other optical modules, and the orchestrator.

The data can be stored in one or more of buffers and a file; the data can be transient and stored for a temporary period of time. The one or more analysis functions can include monitoring and logging specific data, performing calculations based on the data, searching for correlations between the data, and building histograms of the data. The orchestrator can be executed on one or more of a Network Management System (NMS), an Element Management System (EMS), a Software Defined Networking (SDN) controller, and a server executing an SDN application. The application can be written by an end user separate from a manufacturer or developer of the optical module, although other embodiments are contemplated. The optical module can include one of an optical transceiver, an optical amplifier, an optical switch device, a WSS, OPM, a multiplexer/demultiplexer, and any other module or device performing some functionality in the optical network.

### Server

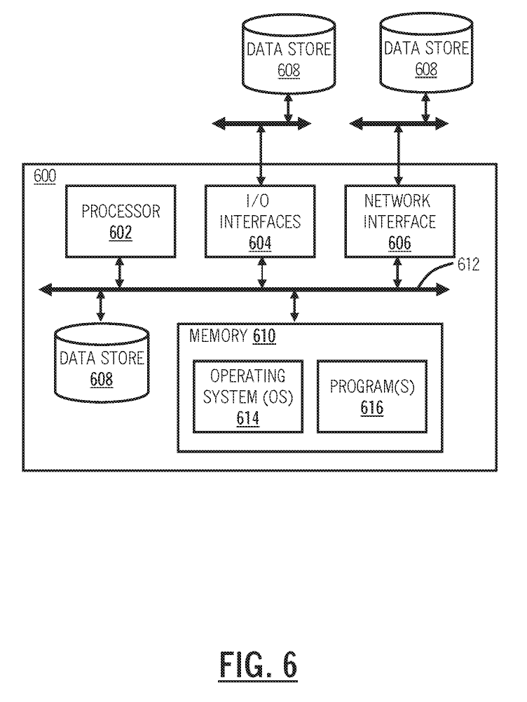

FIG. 6 is a block diagram of an implementation of a server 600 for implementing the orchestrator 390. The server 600 can be a digital computer that, in terms of hardware architecture, generally includes a processor 602, input/output (I/O) interfaces 604, a network interface 606, a data store 608, and memory 610. It should be appreciated by those of ordinary skill in the art that FIG. 6 depicts the server 600 in an oversimplified manner, and a practical embodiment may include additional components and suitably configured processing logic to support known or conventional operating features that are not described in detail herein. The components (602, 604, 606, 608, and 610) are communicatively coupled via a local interface 612. The local interface 612 can be, for example, but not limited to, one or more buses or other wired or wireless connections, as is known in the art. The local interface 612 can have additional elements, which are omitted for simplicity, such as controllers, buffers (caches), drivers, repeaters, and receivers, among many others, to enable communications. Further, the local interface 612 can include address, control, and/or data connections to enable appropriate communications among the aforementioned components.

The processor 602 is a hardware device for executing software instructions. The processor 602 can be any custom made or commercially available processor, a central processing unit (CPU), an auxiliary processor among several processors associated with the server 600, a semiconductor-based microprocessor (in the form of a microchip or chip set), or generally any device for executing software instructions. When the server 600 is in operation, the processor 602 is configured to execute software stored within the memory 610, to communicate data to and from the memory 610, and to generally control operations of the server 600 pursuant to the software instructions. The I/O interfaces 604 can be used to receive user input from and/or for providing system output to one or more devices or components. User input can be provided via, for example, a keyboard, touchpad, and/or a mouse. System output can be provided via a display device and a printer (not shown). I/O interfaces 604 can include, for example, a serial port, a parallel port, a small computer system interface (SCSI), a serial ATA (SATA), a fiber channel, Infiniband, iSCSI, a PCI Express interface (PCI-x), an infrared (IR) interface, a radio frequency (RF) interface, and/or a universal serial bus (USB) interface.

The network interface 606 can be used to enable the server 600 to communicate on a network, such as to the network elements and the optical modules 200, 202, 400. The network interface 606 can include, for example, an Ethernet card or adapter (e.g., 10BaseT, Fast Ethernet, Gigabit Ethernet, 10 GbE) or a wireless local area network (WLAN) card or adapter (e.g., 802.11a/b/g/n/ac). The network interface 606 can include address, control, and/or data connections to enable appropriate communications on the network. A data store 608 can be used to store data. The data store 608 can include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 608 can incorporate electronic, magnetic, optical, and/or other types of storage media. In one example, the data store 608 can be located internal to the server 600 such as, for example, an internal hard drive connected to the local interface 612 in the server 600. Additionally, in another embodiment, the data store 608 can be located external to the server 600 such as, for example, an external hard drive connected to the I/O interfaces 604 (e.g., SCSI or USB connection). In a further embodiment, the data store 608 can be connected to the server 600 through a network, such as, for example, a network attached file server.

The memory 610 can include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 610 can incorporate electronic, magnetic, optical, and/or other types of storage media. Note that the memory 610 can have a distributed architecture, where various components are situated remotely from one another, but can be accessed by the processor 602. The software in memory 610 can include one or more software programs, each of which includes an ordered listing of executable instructions for implementing logical functions. The software in the memory 610 includes a suitable operating system (O/S) 614 and one or more programs 616. The operating system 614 essentially controls the execution of other computer programs, such as the one or more programs 616, and provides scheduling, input-output control, file and data management, memory management, and communication control and related services. The one or more programs 616 may be configured to implement the various processes, algorithms, methods, techniques, etc. described herein.

In an embodiment, the orchestrator 390, i.e., operating on the server 600, is communicatively coupled to one or more optical modules 200, 202, 400 operating in an optical network. The orchestrator 390 includes a network interface 606 and a processor 602 communicatively coupled to one another; and memory 610 storing instructions that, when executed, cause the processor 602 to, via the network interface 606, interact with applications that are locally executed in a sandboxed manner on compute resources associated with one or more optical modules where those applications serve to analyze data generated or obtained by the one or more optical modules during operation, one or more of i) receive pushed data back from the applications executed on the one or more optical modules and ii) receive polled data back from the applications in responsive to a poll, and perform analysis based on the one or more of receive pushed data and receive polled data, wherein the sandboxed manner can include the application being constrained to access the data and analyze the data through execution on the compute resources which are isolated from core resources associated with one or more optical functions of the optical modules. The memory storing instructions that, when executed, can cause the processor to coordinate one or more processes where the application and zero or more applications run on the one or more optical modules within the optical network, the application and the zero or more applications are provisioned and the orchestrator combines results from the one or more of receive pushed data and receive polled data for analysis thereof.

### Framework System for Distributed Measurements and Analysis

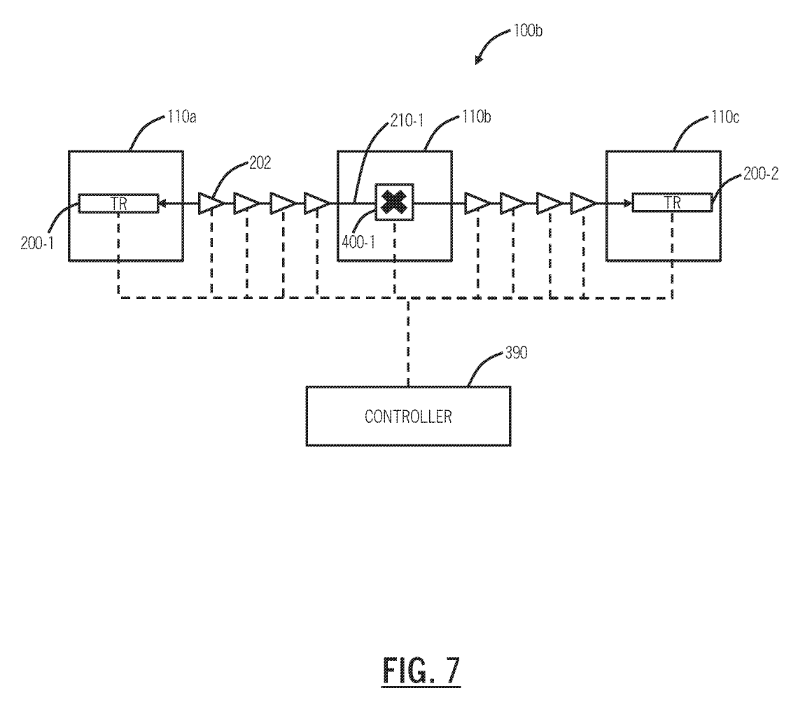

FIG. 7 is a network diagram of an optical network 100b including three sites 110a, 110b, 110c with associated modules 200-1, 200-3, 202, 400-1 in network elements 122, 124 executing distributed measurements and analysis with the orchestrator 390. In this example, there is one channel formed by the optical transceivers 200-1, 200-2 and connected through amplifiers 202 and a WSS optical module 400-1. Of course, other embodiments are also contemplated. Each of these optical modules 200-1, 200-2, 202, 400-1 is configured to execute one or more measurement(s) as described herein and to communicate with the orchestrator 390. The orchestrator 390 can be executed by an NMS, EMS, SDN controller or application, etc. As described herein, the applications can enable one or more optical modules to participate in studies of the optical channel or the like, such as based on direction and control by the orchestrator 390.

Variously, the systems and methods include conducting experiments which combine measurements from an ensemble of the modules 200-1, 200-3, 202, 400-1 that are distributed across the network 100b of a service provider. This includes coordination between the network elements 122, 124 which may be configured to perform different types of measurements with results combined such as via the orchestrator 390 to aid in answering a larger question. U.S. patent application Ser. No. 15/408,602 previously incorporated describes pushing user-defined applications to individual network elements which would have access to PM data that is generated within the network elements as well as communication capability with other network elements and the orchestrator 390. The systems and methods described herein include experiments with different types of measurements where individual modules in the network would each be programmed to gather a subset of those measurements. The orchestrator 390 can coordinate the experiment assigning measurements to individual modules, gather results, and shuffle the assignments between the modules in the network with the goal of answering a larger question.

As described herein, the network element 122, 124 and the associated modules 200-1, 200-3, 202, 400-1 can collect thousands of different PMs. Usually, it is not practical to transfer all of the collected data back to the orchestrator 390 for processing. In most cases, a small subset of the available data is returned to the orchestrator. The PM data may be pre-processed using algorithms stored in the network element 122, 124 firmware or a user-defined application that is executing on the network element 122, 124. The orchestrator 390 can determine which PM data is to be returned and, in some cases, define the pre-processing steps which are to be completed within the network element 122, 124 or modules 200-1, 200-3, 202, 400-1 prior to the data being returned to the orchestrator 390. The orchestrator 390 may also define trigger conditions which control the acquisition and storage of PM data including the data acquisition conditions such as the sample rate.

The systems and methods recognize that it is often desirable to conduct experiments which utilize data which in principle exists within a network but cannot be collected by a single network element 122, 124 or module 200-1, 200-3, 202, 400-1 due to physical limitations of that device (e.g., bandwidth, processing power, etc.) or because the experiment involves watching for events which are transitory and have a low probability of being detected by any given network element 122, 124 or module 200-1, 200-3, 202, 400-1 over a reasonable timescale. For situations such as these, it is desirable to distribute the measurements across an ensemble of network elements 122, 124 or modules 200-1, 200-3, 202, 400-1 with the overall experiment coordinated by the orchestrator 390.

### Distributed Measurement Process

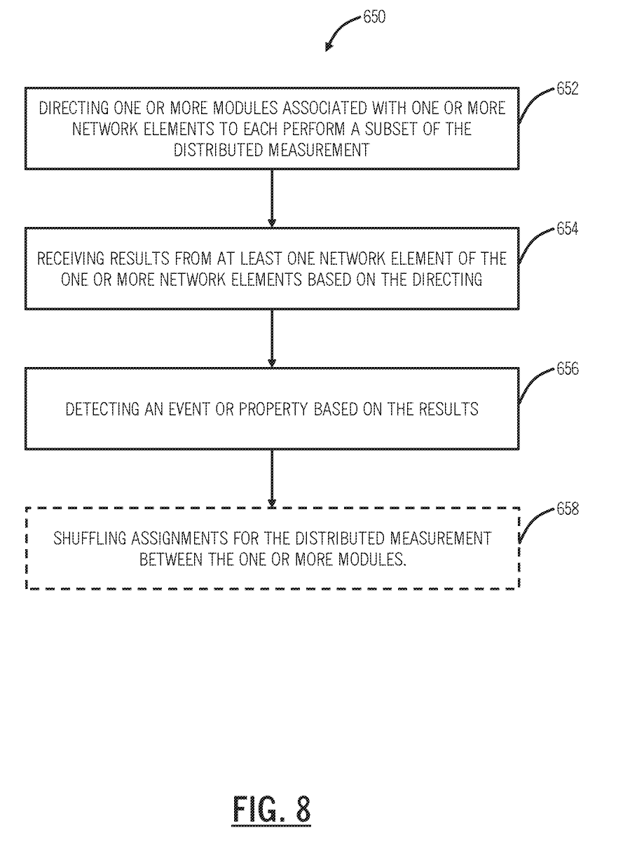

FIG. 8 is a flowchart of a distributed measurement process 650. The process 650 can be implemented by the orchestrator 390. The process 650 includes directing one or more modules associated with one or more network elements to each perform a subset of the distributed measurement (step 652); receiving results from at least one network element of the one or more network elements based on the directing (step 654); and detecting an event or property based on the results (step 656). The process 650 can further include shuffling assignments for the distributed measurement between the one or more modules (step 658). The process 650 can be used to detect an event or a property of the network such as whether or not two PMs are correlated.

The subset of the distributed measurement can be based on performance monitoring data. The results can be based on the local analysis performed by the one or more modules on the subset of the distributed measurement. The results can be based on a trigger condition detected locally by the associated module. The directing step 652 can include control of the one or more modules to modify data acquisition characteristics for the subset. The directing step 652 to a specific module can be modified based on a signal from another module or network element or the orchestrator.

The distributed measurement can be for polarization transient, and the one or more modules can include a plurality of modules associated with channels over a same link, and the plurality of modules are set to different sampling rates. The distributed measurement can be to identify a nonlinear process on a link, correlate the nonlinear process with frame error events, and identification of a module responsible for the frame error events. The distributed measurement can be to discover a correlation between performance monitoring data utilizing machine learning. The distributed measurement can be to detect errors in sections in a meshed optical network by sampling signal-to-noise ratio at the one or more network elements.

In another embodiment, an orchestrator configured to perform distributed measurement in a network includes a processor; and memory storing instructions that, when executed, cause the processor to direct one or more modules associated with one or more network elements to each perform a subset of the distributed measurement, receive results from at least one network element of the one or more network elements based on the direction, and detect an event based on the results.

In a further embodiment, a non-transitory computer-readable medium storing instructions executable by a processor, and, in response to such execution, causes the processor to perform operations including directing one or more modules associated with one or more network elements to each perform a subset of the distributed measurement; receiving results from at least one network element of the one or more network elements based on the directing; and detecting an event based on the results.

In another further embodiment, a process for detection of anticipated network events is through transductions obtained from one or more network elements. A transduction is the action or process of converting something into another form Thus measures of physical layer and other network features are transduced from lower level measures made in a network element. Here, the one or more network elements participate in the detection, i.e., a distributed measurement. Transductions are disposed to network elements and processed by the orchestrator 390 for the detection. The transductions and their disposition amongst network elements are particular to the nature of the anticipated event, and the disposition of transductions for detection is episodic.

The control of a network element involves modifying the data acquisition characteristics of that network element such as sample rate, gate time, wavelength, gain, sensitivity, channel, modulation format, routing, etc. The data is acquired with one or more sets of data acquisition parameters where the sets of parameters are assigned and distributed to individual network elements that participate in the experiment. The data acquisition parameter assignments can be occasionally shuffled between the network elements by the orchestrator 390.

The data acquisition of a network element is modified in response to a signal sent by another network element or from the orchestrator 390. A network element can send a signal to one or more network elements or to the orchestrator 390 in response to the observation of a condition that is defined within the network element. The orchestrator 390 can use machine learning algorithms to discover the relation between PM data that are predictive of some measure of network performance such as BER, FER, etc. The orchestrator 390 can search for combinations of PM data that correlate with network performance by configuring network elements to search for correlations between subsets of PM data.

The orchestrator 390 can shuffle the PM assignments between the network elements participating in the experiment. An algorithm such as a genetic algorithm or sampling techniques such as Monte Carlo sampling can be used to select candidate combinations of PM data to test in the network. The orchestrator uses machine learning algorithms to predict some measure of network performance such as BER, FER, etc. The orchestrator 390 can configure a network element with processing steps that are to be performed on the captured PM data.

The detection of anticipated network events is by transductions assigned to groups of affected network elements. A group can include one or more network elements, the transductions assigned to groups may be independent, the transductions are disposed to network elements and processed to detection by the orchestrator 390, etc. The transductions and their disposition amongst network elements are particular to the nature of the anticipated event, and the disposition of transductions for detection is episodic.

### Sampling and Event Detection

In an example application, the distributed measurement process 800 and framework can be used for capturing PM data for an event that is detectable by multiple modules 200, 202, 400 that form one or more channels that co-propagate over some portion of a link. One example of this is detecting polarization transient events which occur when the birefringence of an optical fiber abruptly changes in response to some external force such as mechanical bending of the fiber or a nearby lightning strike. The polarization state of channels propagating through the fiber will be modified by the transient, and each channel's receiver will attempt to digitally compensate for changes in the received polarization state. It is desirable to monitor the level of polarization activity on a link 120 as that information can be used to predict the probability for a module 200, 202, 400 encountering polarization transient events which cannot be tracked.

Characterizing polarization activity on a link 120 is challenging because of the wide variation in polarization rotation rates that can be produced on the link 120. Rotation rates can vary from nearly constant under laboratory conditions or for well-behaved undersea fiber or can exceed 10 MRad/s for links carrying traffic over Optical Ground Wire (OPGW) fiber in the vicinity of a lightning strike (see D. Charlton et al. “Field measurements of SOP transients in OPGW, with time and location correlation to lighting strikes”, Optics Express 25 (9), pp. 9689, 2017).

When capturing data with an optical modem 200, there can be a tradeoff between the maximum sample rate of the device and the duration of data which is captured. For example, it may be able to sample one out of every 1000 half bursts where the received symbols will be made available to firmware along with the corresponding error-free bits. The received symbols are compared with the transmit symbols (calculated from the error-free bits) and can be used, along with receiver parameters such as the LMS tap coefficients and carrier recovery phase estimates, to calculate the time-dependent channel matrix. For a 75 GBaud waveform, the channel is effectively sampled at 75 GS/s for 1 half burst (˜5.25 ns) out of every 1000 half bursts. The 5.25 ns gate time is dictated by the memory bandwidth between the ASIC and the modem's 200 microprocessor. For the same bandwidth constraint, it should be possible to sample every other symbol for twice as long or every fourth symbol for four times as long, etc.

By taking advantage of the fact that transient events impact multiple cards which co-propagate through the same link, an experiment can be designed where each modem 200 monitors the channel with a different tradeoff between sample rate and gate time. In doing so, it is more likely that the sampling conditions for at least one of the modems 200 will match a given transient. The orchestrator 390 can configure the modems 200 on a link 120 to sample at different rates with corresponding gate times. The orchestrator 390 could also in principle arrange the relative delays between the times when each modem 200 is sampling to maximize coverage or the fraction of the time where at least one modem 200 is sampling at a given rate. In doing so, the orchestrator 390 can coordinate a measurement involving multiple modems 200 which exceeds the sampling capability of any one modem 200. The orchestrator 390 can improve the experiment by periodically shuffling the sample rate/gate time assignments between the modems 200 on the link. Through statistical analysis of the results, the extent to which events are common to the channels in the link 120 can be determined and to look for systematic variations between channels.

### Interfering Channel Detection

In another example application, the distributed measurement process 800 and framework can be used for interfering channel detection, i.e., the distributed measurement process 800 and framework is not limited to detecting polarization transients. The detection of any event which is experienced by multiple network elements 122, 124 can benefit from a distributed measurement that is coordinated by the orchestrator 390. There are conditions where the characteristics of one channel propagating through a link 120 can adversely affect the performance of other channels that co-propagate through the same link 120. For example, intensity fluctuations from one channel directly modify the phase of the other channels through Cross Phase Modulation (XPM) and can induce cycle slips and frame errors. A poorly behaved modem 200 could transmit a waveform which incites a large number of cycle slips or frame errors on other modems 200. This condition could be caused by a hardware malfunction, poor frame design, or other factors. Experience has shown that it is very difficult to determine the origin of events that cause frame errors because they can occur infrequently and can be caused by processes that act over a wide range of timescales.

For example, consider a case where one modem 200 on a compensated submarine link transmits zero field line patches (occasional groups of zero power symbols that are meant to be used for framing). The power modulation associated with such a line patch can induce cycle slips and frame errors on the other co-propagating channels. If frame errors are detected on a link 120, experiments could be designed and coordinated by the orchestrator 390 to determine root cause. The orchestrator 390 could start by configuring a fraction of the modems 200 on the link 120 to detect common mode phase variations with subsets of the modems 200 assigned to sample at various sample rates. Other modems 200 could be assigned to detect different suspected causes of the frame errors such as polarization activity or OSNR variations. Of note, these are in-service measurements on traffic carrying cards. The modems 200 acquire data for a set period, and then their assignments can be shuffled to ensure that over time each type of signature is looked for in each part of the spectrum. This approach would detect that for the case of zero field line patches, common mode phase excursions matching the line patch duration are present in the link 120 and would also provide enough data on the magnitude of the phase excursions and their rate of occurrence to determine if they are likely to be responsible for the observed frame errors.

At that point, a new experiment could be devised to determine if common mode phase excursions correlate with observed frame errors. Each modem 200 on the link 120 could be configured to sniff for common mode phase excursions with the same rate and gate times which are chosen based on the signature that was observed in the previous step. Sniffed data would be stored in a circular buffer within each modem 200 for some length of time and then overwritten. If each modem 200 cannot sample at the necessary rate continuously, the modem 200 can be arranged into groups with their gate times staggered to ensure full coverage. Each modem 200 would also be configured to signal the other modems 200 if a frame error is detected. This signaling could go directly between modems 200 through the shelf processor, controller, etc. (east-west) or through the orchestrator 120 (north-south). Each modem 200 would also be configured to copy the circular buffer contents to a more permanent storage location along with information such as time stamps and an event identifier when a signal is received that a frame error was detected by one of the modems 200 on the link 120. Provided that the circular buffer is longer than the time required to signal the detection of a frame error between the modems 200 this approach would capture the phase record for all of the modems 200 on the link 120 during the time that the frame error occurred in one of the modems 200. This data can then be used to prove that the common mode phase excursions are responsible for frame error events.

The data can also be used to look at the magnitude of the common mode phase excursions as a function of channel wavelength. Line patches induce common mode phase shifts in co-propagating channels through XPM, which exhibits a low pass transfer function characteristic. Channels closest to the aggressor will experience the largest phase shift during a line patch, and that phase shift will decay as the wavelength separation increases. For the case of line patches, this example shows how a coordinated measurement could be used to identify a nonlinear process that is present in the link 120, correlate that process with frame error events, and then identify the modem 200 responsible for the frame errors.

### Machine Learning

Recently, machine learning has been used to discover the subtle relations between PM data that are indicative of the health of network elements 122, 124 as well as the network 100 itself. The network elements 122, 124 can have thousands of PMs, so it is not practical to search for relevant correlations by sending all of the data to a central location. The distributed measurement approach could be used to facilitate deep learning where the orchestrator 390 posits combinations of PMs which could correlate with some measure of performance such as BER. The network elements 122, 124 within the link 120 would be provisioned by the orchestrator 390 to search for correlations within a given subset. The results would aggregate back to the orchestrator 390 which would shuffle the assignments between the network elements 122, 124 and posit new combinations of PMs to test. The selection and update of the combinations of PMs to be tested could, for example, come from a genetic algorithm. The PMs which are determined to be important could serve as inputs to deep learning algorithms which are trained to predict performance. By having the orchestrator 390 distribute the machine learning activities to a large ensemble of network elements 122, 124, it should be possible to discover correlations between PMs much faster than would otherwise be possible.

### Meshed Network Analysis

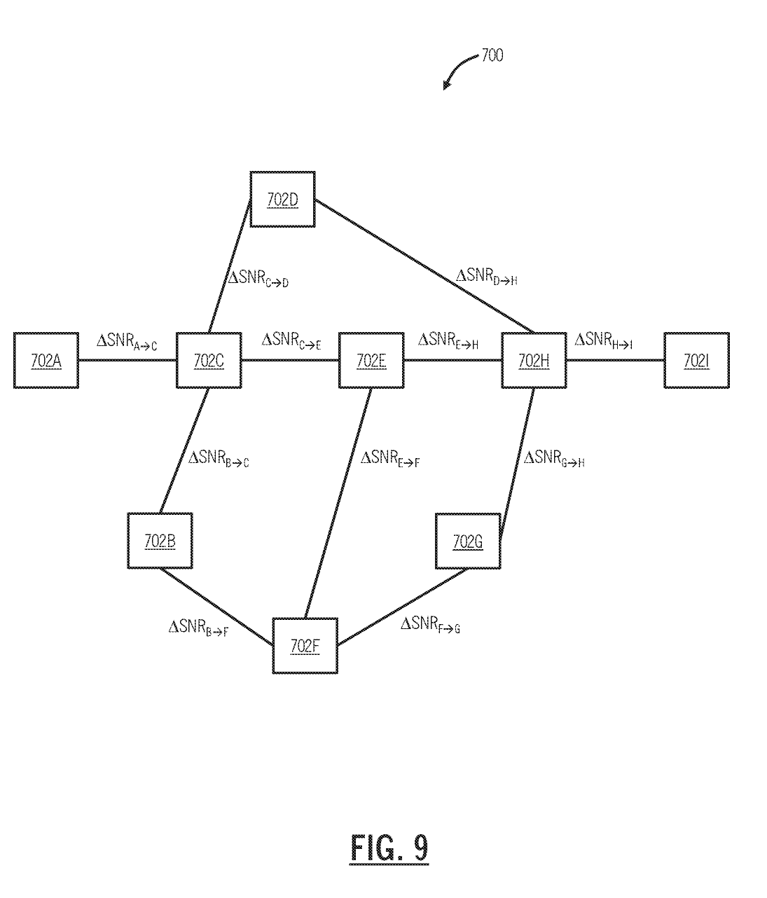

FIG. 9 is a network diagram of a mesh optical network 700 with a plurality of network elements 702 (labeled as 702A-702I) interconnected to one another. Distributed measurement techniques can be used to identify underperforming links 120 within the mesh optical network 700 by searching for combinations of underperforming channels that share a common path. The network elements 702 can be Optical Add/Drop Multiplexers (OADM). For example, some possible routes for groups of channels can include

Group 1 channels: A→C→E→H→I

Group 2 channels: B→C→E→H→I

Group 3 channels: B→C→E→F→G

Group 4 channels: C→D→H→I

For example, the photonic control 150 can calculate incremental (O)SNR on a per channel basis and the objective function can be to equalize incremental (O)SNR per domain/section across all channels. This means data on the incremental (O)SNR from each section can be pulled and concatenated along paths to determine what the approximate (O)SNR at the receiver should be (assuming the starting (O)SNR is known).

For example, assume there is a hardware issue on an amplifier in section 702E→702H which manifests as poor noise figure performance (perhaps pump ratio is set wrong because pumps have aged, and there is no alarm), for this reason, expected incremental SNR in this section is worse than expected but the system is unaware of this since it is performing modeling in the section based on card calibration table data measured in the factory on the amps.

Because of this issue, the channels in Group 1 and Group 2 are experiencing worse SNR at the receiver than expected by concatenating the incremental SNR as measured in each section. A distributed experiment can be performed to intelligently sample the receiver SNR (e.g., collect pre-FEC BER and convert approximately to (O)SNR) at different nodes in the system based on differing paths, it can be determined that the error must be in section 702E→702H since the Group 3 and 4 channels do not experience the problem and the only overlap between Group 1 and Group 2 that does not overlap with Group 3 or Group 4 is in that domain. Once it is known that there is an issue in that domain, it can be decided to re-route traffic onto other routes or at least alert a higher-level user that there is something causing SNR degradation further than the system is predicting within that domain.

The distributed measurement technique could be used passively where the link 120 is examined as provisioned. The orchestrator 390 would identify channels which co-propagate through one (or a small number) of spans and would check for consistency between the predicted and measured channel performance.

The technique could also be implemented actively where a test channel is sent through the network 700 with its performance measured and compared with expectation. The channel could then be re-routed and the comparison repeated. Results could be compared between paths that terminate at the same endpoint and paths that terminate at different endpoints where receivers at a given endpoint would be provisioned to receive the test channel. This approach allows for detection of underperforming spans as well as consistency checks where experiments are repeated where a test channel propagates through the same span and is routed to different receivers as well as where the same receiver is used for cases where test channels transverse the network along different paths.

It will be appreciated that some embodiments described herein may include one or more generic or specialized processors (“one or more processors”) such as microprocessors; Central Processing Units (CPUs); DSPs: customized processors such as Network Processors (NPs) or Network Processing Units (NPUs), Graphics Processing Units (GPUs), or the like; FPGAs; and the like along with unique stored program instructions (including both software and firmware) for control thereof to implement, in conjunction with certain non-processor circuits, some, most, or all of the functions of the methods and/or systems described herein. Alternatively, some or all functions may be implemented by a state machine that has no stored program instructions, or in one or more ASICs, in which each function or some combinations of certain of the functions are implemented as custom logic or circuitry. Of course, a combination of the aforementioned approaches may be used. For some of the embodiments described herein, a corresponding device in hardware and optionally with software, firmware, and a combination thereof can be referred to as “circuitry configured or adapted to,” “logic configured or adapted to,” etc. perform a set of operations, steps, methods, processes, algorithms, functions, techniques, etc. on digital and/or analog signals as described herein for the various embodiments.

Moreover, some embodiments may include a non-transitory computer-readable storage medium having computer readable code stored thereon for programming a computer, server, appliance, device, processor, circuit, etc. each of which may include a processor to perform functions as described and claimed herein. Examples of such computer-readable storage mediums include, but are not limited to, a hard disk, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory), Flash memory, and the like. When stored in the non-transitory computer-readable medium, software can include instructions executable by a processor or device (e.g., any type of programmable circuitry or logic) that, in response to such execution, cause a processor or the device to perform a set of operations, steps, methods, processes, algorithms, functions, techniques, etc. as described herein for the various embodiments.

Although the present disclosure has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following claims.

What is claimed is:

1. A method for distributed measurement in a network implemented by an orchestrator, the method comprising:
directing one or more modules associated with one or more network elements to each perform a subset of the distributed measurement;
receiving results from at least one network element of the one or more network elements based on the directing; and
detecting an event or property based on the results.

2. The method of claim 1, wherein the subset of the distributed measurement is based on performance monitoring data.

3. The method of claim 1, further comprising:
shuffling assignments for the distributed measurement between the one or more modules.

4. The method of claim 1, wherein the results are based on local analysis performed by the one or more modules on the subset of the distributed measurement.

5. The method of claim 1, wherein the results are based on a trigger condition detected locally by the associated module.

6. The method of claim 1, wherein the directing comprises control of the one or more modules to modify data acquisition characteristics for the subset.

7. The method of claim 1, wherein the directing to a specific module is modified based on a signal from another module or network element or the orchestrator.

8. The method of claim 1, wherein the distributed measurement is for polarization transient, and wherein the one or more modules comprise a plurality of modules associated with channels that co-propagate over all or part of the same link and the plurality of modules are set to different sampling rates.

9. The method of claim 1, wherein the distributed measurement is to identify a process on a link and correlate the process with error events to provide an identification of a module responsible for the error events.

10. The method of claim 1, wherein the distributed measurement is to discover correlation between performance monitoring data, and possibly other data sources, utilizing machine learning.

11. The method of claim 1, wherein the distributed measurement is to detect errors in sections in a meshed optical network by sampling signal-to-noise ratio at the one or more network elements.

12. An orchestrator configured to perform distributed measurement in a network, the orchestrator comprising:
a processor; and
memory storing instructions that, when executed, cause the processor to
direct one or more modules associated with one or more network elements to each perform a subset of the distributed measurement,
receive results from at least one network element of the one or more network elements based on the direction, and
detect an event or property based on the results.

13. The orchestrator of claim 12, wherein the subset of the distributed measurement is based on performance monitoring data.

14. The orchestrator of claim 12, wherein the memory storing instructions that, when executed, further cause the processor to
shuffle assignments for the distributed measurement between the one or more modules.

15. The orchestrator of claim 12, wherein the results are based on local analysis performed by the one or more modules on the subset of the distributed measurement.

16. The orchestrator of claim 12, wherein the results are based on a trigger condition detected locally by the associated module.

17. The orchestrator of claim 12, wherein the one or more modules are directed to modify data acquisition characteristics for the subset.

18. A non-transitory computer readable medium storing instructions executable by a processor, and, in response to such execution, causes the processor to perform operations comprising:
directing one or more modules associated with one or more network elements to each perform a subset of the distributed measurement;
receiving results from at least one network element of the one or more network elements based on the directing; and
detecting an event or property based on the results.

19. The non-transitory computer readable medium of claim 18, wherein the subset of the distributed measurement is based on performance monitoring data.

20. The non-transitory computer readable medium of claim 18, wherein the instructions further cause the processor to perform operations comprising:
shuffling assignments for the distributed measurement between the one or more modules.
